(19) United States
(12) Patent Application Publication
(10) Pub. No.: US 2002/0016662 A1
(43) Pub. Date: Feb. 7, 2002

(54) Method and arrangement for automatically correcting current setpoints for operating at least one drive unit fed from a power supply system by including the current consumption of other consumers supplied by the power supply system

(76) Inventors: Werner Belschner, Notzingen (DE); Jochaim Blum, Deizisau (DE); Michael Procter, North Vancouver (CA)

Correspondence Address: CROWELL & MORING, L.L.P., Suite 700, 1200 G Street, N.W., Washington, DC, 20005, US

(21) Appl. No.: 09/858,884

(22) Filed: May 17, 2001

(30) Foreign Application Priority Data
May 17, 2000 (DE) 100 24 259.6

(51) Int. Cl. G06F 17/00

(52) U.S. Cl. 701/70; 701/1

(57) ABSTRACT

A method and an arrangement for automatically correcting vehicle current setpoints which are respectively assigned to a specific position of an accelerator pedal, to the rotational speed and the voltage of a power supply system for at least one drive unit of a vehicle. The vehicle current setpoints are adjusted, taking into account the current output in the vehicle at the instant of the setpoint stipulation by means of a power supply system.

### BACKGROUND AND SUMMARY OF THE INVENTION

This application claims the priority of German Patent Document 100 24 259.6, filed May 17, 2000, the disclosure of which is expressly incorporated by reference herein.

The invention relates to a method and an arrangement for automatically correcting a current setpoint, which can be influenced by the respective accelerator pedal position of a vehicle, for operating at least one electric drive unit supplied with current by a power supply system, having a setpoint which includes both the current for the drive unit and currents which are output additionally to electric devices by the power supply system. The vehicle setpoints are stored, such that they can be read out, in characteristic diagrams as a function of the accelerator pedal positions, the rotational speeds, of the drive unit and the voltage values, provided during operation of the vehicle, of the power supply system, and/or being capable of calculation by means of formulae. The vehicle current setpoint corresponding to the respective accelerator pedal position and the respectively existing rotational speed of the drive unit and voltage of the power supply system being read out from the characteristic diagrams and/or calculated using the formulae, and a sum being formed from the vehicle current setpoint and the value, corresponding to the respective operating state and read out from characteristic diagrams, of the intrinsic consumption of the power supply system being formed.

A method and an arrangement of the type described above are disclosed in German reference DE 195 40 824 A1.

Accurate detection of the currents of the various secondary units in the vehicle presupposes a large expense for calibrating the characteristic diagrams. In addition, further influences can disadvantageously affect an accurate assessment of the current consumption. The traction motor current consumption changes, for example, through ageing of the motor. Defective or inaccurately recorded characteristic diagrams cause uncertainties with reference to the determination of the current consumption.

Furthermore, the current requests of the electric device of the vehicle do not remain constant. Some devices, such as headlights, are required only in the case of darkness and/or rain. The heating or air-conditioning is switched on depending on the season and the air temperature. Other devices, such as window drive motors or the sliding roof motor are switched on only for a short time. As a result, the current consumption in the vehicle changes frequently.

An object of the invention is to provide a corrected setting of the current setpoints of a power supply system which supplies, in a vehicle, at least one electric drive unit and further electrical devices. This is accomplished by a method and an arrangement which, in association with a low outlay, permits a sufficiently accurate, automatic adaptation of the current setpoint to the current consumption of the power supply system, the drive unit and of consumers whose current values are not determined from characteristic diagrams.

According to the invention, the problem is solved by using the difference formed between the current consumed in the vehicle at the instant of the respective stipulation of the vehicle current setpoint and the sum, and using that given existing difference a dynamically corrected differential current setpoint is added with the correct sign to the sum of the vehicle current setpoint and intrinsic consumption current setpoint in order to form the corrected current setpoint from which the current output of the power supply system is determined.

The dynamic correction can produce P (Proportional), PI (Proportional-Integral) or PID (Proportional Integral-Derivative) behaviours. This depends on the properties of the power supply system, to which the behaviour is adapted. Accelerator pedal position is to be understood as a regulating unit which, by means of foot or hand actuation, prescribes position-dependent values, for example, angular position values. The characteristic curves of the values of the vehicle current setpoints, as a function of the accelerator pedal positions, the rotational speeds, the drive unit and the voltages of the power supply system, can be measured with the aid of a test vehicle, and can be adopted in the case of other vehicles having the same design as the test vehicle.

Characteristic diagrams are preferably used on a test vehicle by determining operating points of the test vehicle and storing them in a control unit to be referenced during operation of a fuel cell vehicle of the same type. With a prescribed motor speed of the test vehicle, and given an accelerator pedal position of between 0% and 100%, the determination is made of the current setpoint of the fuel cell which is required for the torque requested by means of the accelerator pedal. During operation of a fuel cell vehicle, the control unit is supplied with the accelerator pedal position, rotational speed and voltage level of the fuel cell, and the current setpoint is taken from the characteristic diagrams in the control unit and passed onto the fuel cell system.

If the characteristic diagrams or characteristic curves show relationships, which can be expressed by formulae and/or equations, between the aforementioned variables, the formulae and/or equations can then be stored and used to determine the values of the vehicle current setpoints. It is thus possible, if appropriate, to economize on memory capacity. The assignment of the accelerator pedal positions to a specific power is a function of rotational speed. That is, at standstill the full excursion of the accelerator pedal signifies the maximum acceleration, while in the case of higher rotational speeds it is necessary to generate the full power of the travelling drive. Other motor-driven mobile devices such as boats, ships, and railbound vehicles can function equivalently. In this case, in the prior art, it is virtually impossible to take account in the characteristic diagrams or characteristic curves of changes in the system properties such as, for example, owing to ageing or change in the fuel cell characteristic.

The invention produces a corrected setpoint which includes not only a fraction of the current drive unit, but also a fraction of the currents drawn from the power supply unit by the remaining devices in the vehicle at the respective current instant of the setpoint stipulation.

In a preferred embodiment, the power supply system is a fuel cell system with a fuel cell for the current output, data on the intrinsic current consumption of the fuel cell system are stored in the characteristic diagrams, and the dynamically corrected differential current setpoint is added with the correct sign to the sum of the vehicle current setpoint and the respective value of the intrinsic current consumption of the fuel cell system in order to form the corrected current setpoint, at which the fuel metering of the fuel cell is determined for its current output.

The corrected current setpoint determines the fuel metering of the fuel cell system. Fuel metering in accordance with a current setpoint is known per se in fuel cell systems.

The intrinsic current consumption of the fuel cell system can be recorded with high accuracy by characteristic diagrams as a function of the currents output by the fuel cell, in particular a PEM cell. These characteristic diagrams are used to assign the intrinsic current consumption of the fuel cell system to the vehicle current setpoints. These characteristic diagrams are stored in the motor vehicle and read out as estimated values during operation. The current consumption of the fuel cell system is determined by the auxiliary units such as compressor, high-pressure compressor and actuators such as valves and electric heaters. It is not possible to estimate accurately the current consumption of the electric consumers in the low-voltage network, for example the 12 V network of the vehicle, which includes a battery, wiper motors, window drive motors, seat positioning motors, headlights, lamps, an air-conditioning unit, etc.

The method according to the invention produces a corrected current setpoint which corresponds to the actual current requirement of the drive unit and the other devices fed from the power supply unit, doing so largely in the various operating states, that is, in the operating range of the power supply system. Avoiding differences between the current setpoint and the actual current consumption results in fewer difficulties or disturbances during operation of the fuel cell such as drying out of the proton-conducting diaphragm, an unstable mode of operation of the fuel cell system, voltage dips, overheating or switching off of the fuel cell. The method according to the invention therefore also avoids difficulties which arise during idling operation, at which time inaccuracies relating to the current setpoint are particularly serious.

In a preferred embodiment, the dynamically corrected differential current setpoint is added, with a time delay which is greater than the delay time of the fuel cell system, to the sum of the vehicle current setpoint and intrinsic consumption current value in order to form the corrected current setpoint, which determines the fuel metering of the fuel cell. The dynamic setting of the corrected current setpoints is thereby tuned to the delay time of the fuel cell system such that no instability occurs in the mode of operation of the fuel cell.

The total current consumed in the vehicle at the instant of vehicle current setpoint stipulation is preferably measured by means of at least one current transformer which is arranged at an electric output of the fuel cell upstream of branches to electrical devices. The outlay for measuring technology is particularly low with this embodiment.

It is an object of the present invention to provide an arrangement for automatically correcting a current setpoint, which can be influenced by the respective accelerator pedal position of a vehicle, for operating at least one electric drive unit supplied with current by a power supply system. The arrangement provides a setpoint which includes both the current for the drive unit and currents which are output additionally to electric devices by the power supply system, an accelerator pedal position transmitter connected to an accelerator pedal in the vehicle, and one transmitter each for measuring the output current and the voltage of a fuel cell (2) of the fuel cell system (1). The rotational speed signal of the drive unit is connected to a controller which is arranged in the vehicle and in which vehicle current setpoints are stored, such that they can be read out, in characteristic diagrams as a function of the accelerator pedal positions, the rotational speeds of the drive unit and the voltage values, provided during operation of the vehicle, of the power supply system, and/or can be calculated by formulae. The vehicle current setpoint, corresponding to the respective accelerator pedal position and the respectively existing rotational speed of the drive unit and voltage of the power supply system, is read out from the characteristic diagrams and/or is calculated using the formulae, and a sum is formed from the vehicle current setpoint and the value, corresponding to the respective operating state and read out from characteristic diagrams, of the intrinsic consumption of the power supply system. The problem is solved according to the invention because the controller determine the difference between the total current consumed in the vehicle at the instant of the respective stipulation of a vehicle current setpoint and the sum of the vehicle current setpoint and the value of the respective intrinsic consumption of the power supply system. This existing difference allows the controller to produce a dynamically corrected differential current setpoint with the correct sign relative to the sum of the vehicle current setpoint and intrinsic consumption value in order to form the corrected current setpoint. With this corrected setpoint, the current output of the power supply system can be set. Intrinsic current requirement is to be understood as the current requirement of the power supply system which is necessary in order for the power supply system to be able to supply current to other electric devices. The corrected current setpoint takes into account the power consumption not only of the drive unit but also of the other device which are already drawing current at the instant that the power supply system is stipulating the vehicle current setpoint. The term voltage refers in this case to the voltage across the poles of the power supply system or its output voltage.

In particular, the power supply system is a fuel cell system requiring auxiliary units for operation. Auxiliary units include, for example, a compressor, a fan drive etc. The output current of the fuel cell includes the current consumption of the fuel cell system, of the vehicle drive and of further current consuming devices. In particular, the low-voltage network of, for example, 12-14 V included in the vehicle in addition to the high-voltage network of the fuel cell has numerous devices such as lights, lamps, wiper motors, an air-conditioning system, a heater, turn signal lamps, headlights, the power supply for the controller etc., whose currents are likewise included in the total current. The controller preferably includes a microprocessor with an A/D converter whose input is connected to the transmitter for measuring the output current of the fuel cell. A current transformer, in particular, is connected downstream of an electric output of the fuel cell in order to measure the output current of the fuel cell.

The power of the fuel cell, and thus the level of the output current is influenced by feeding in the fuel, which is particular, hydrogen and the oxidant, for example, air. A certain delay occurs between the stipulation of a dynamically corrected current setpoint and the generation of a corresponding fuel cell output current. In a preferred embodiment, the controller includes a delay element which is tuned to the delay time of the fuel cell system in such a way that the change in the dynamically corrected current setpoint is slower than the change in the output current of the fuel cell given a change in the current setpoint. A stable mode of operation in conjunction with changes in setpoint is achieved by means of the time delay of the delay element.

Other objects, advantages and novel features of the present invention will become apparent from the following detailed description of the invention when considered in conjunction with the accompanying drawings.

### BRIEF DESCRIPTION OF THE DRAWINGS

FIG. 1 illustrates the principle of a fuel cell system and of electric consumers which are arranged in a vehicle which is driven by an electric traction motor and has a controller for the fuel cell system and the traction motor,

FIG. 2 is a block diagram with details of the controller illustrated in FIG. 1.

### DETAILED DESCRIPTION OF THE EMBODIMENTS

A power supply system, designed as a fuel cell system includes a fuel cell 2, in particular a PEM cell, which is fed a fuel, in particular hydrogen, via a first feed pipe 3 in which a valve 4 is arranged. A pressure regulator 5 can be arranged in the course of the feed pipe 3. The hydrogen can originate from a container or from a device in which hydrogen is generated in a way known per se from liquid fuel. A second feed pipe 6, in which an air filter 7, an air mass meter 8 and a compressor 9 are arranged, provides the fuel cell 2 with an oxidant such as oxygen which is contained in the air sucked in from the surroundings. The fuel cell 2 includes individual modules which are connected electrically in series and in which an electrochemical reaction between two electrodes, which are separated from one another by a proton-conducting diaphragm, generates electric energy. The fuel cell system also includes an electric motor 10 for driving the compressor 9.

The electric motor 10 is fed from a converter 11 which is arranged in a high-voltage network 12 which is connected to the outputs of the fuel cell 2. The converter 11 is used to control the rotational speed of the electric motor 10, and thus that of the compressor 9. The rotational speed of the compressor 9 controls the oxidant mass flow, and thus the power provided by the fuel cell 2. The output current of the fuel cell 2 is measured by ammeter 13 and the output voltage of the fuel cell 2 is measured by voltmeter arrangement 14. The gases produced by the chemical reaction in the fuel cell 2 are fed off via a first outflow pipe 15 in which there can be a pressure regulator valve 16 which is used to set the operating pressure in the fuel cell 2 to a desired value. The fuel cell 2 includes a second outflow pipe 18, in which there can be a further valve 17. It is also possible to operate the fuel cell 2 without the valves 16 and 17 in the outflow pipes 15 and 18.

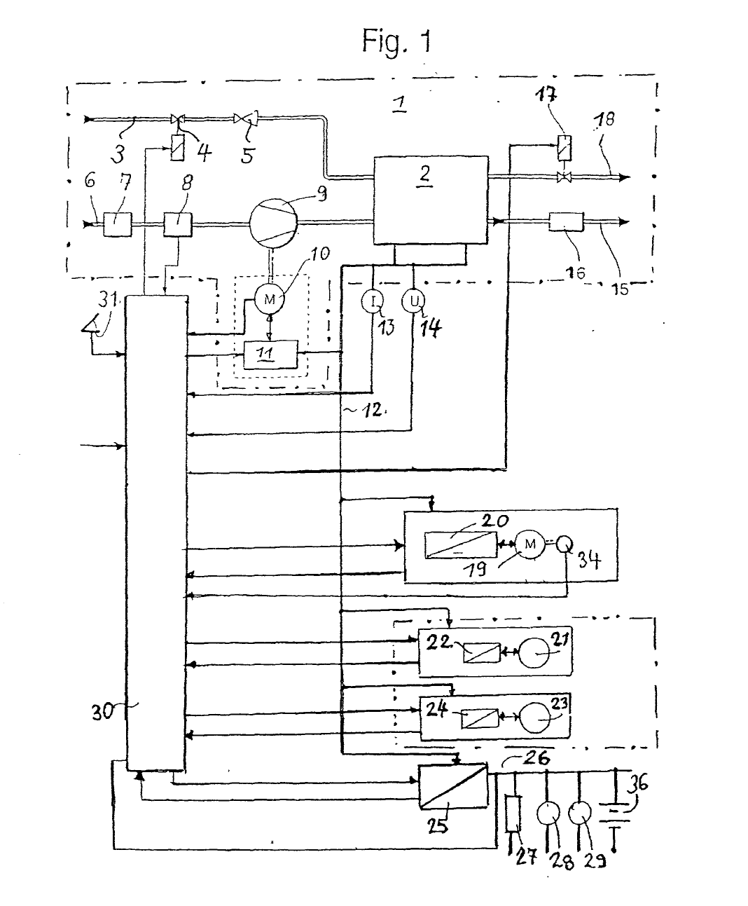

The vehicle is driven by at least one electric traction motor 19 which is connected to a traction converter 20 supplied with electric energy by the high-voltage network 12. The vehicle also includes a cooling water pump (not illustrated) which is driven by an electric motor 21 which is fed from a converter 22. The vehicle also includes a fan (not illustrated) is driven by an electric motor 23 and is fed from a converter 24. The two converters 22, 24 are also connected to the high-voltage network 12 which typically has a voltage of 200 V or more. A further converter 25 is connected on one side to the high-voltage network 12, and on the other side to a low-voltage network 26 in the vehicle. The low-voltage network 26, (i.e., the second vehicle electrical system) is intended for supplying energy to a series of electric devices are illustrated in FIG. 1 by way of example. These are heating resistors 27, motors 28, 29 for wipers etc., and a controller 30 with at least one microprocessor. A battery 36 is also connected to the network 26.

The controller 30 is connected to the transmitter 13, to the measuring arrangement 14, to the converter 11, to a tachometer generator (not illustrated in more detail) at the motor 10, to the valve 4, to the air mass sensor 8, to the valve 17, to the converters 20, 22, 24 and 25 and to a tachometer generator (not illustrated) of the traction motor 19. A controller 30 is also connected to an accelerator pedal position transmitter of an accelerator pedal 31.

The controller 30 receives information concerning, inter alia, the air mass flow, the rotational speeds of the motor 10 and the traction motor 19, the output current of the fuel cell 2, the output voltage of the fuel cell 2 and the operating states of the converters 11, 20, 22, 24 and 25, as well as the positional value generated by the accelerator pedal position transmitter. The controller 30 processes the information and generates actuating signals for the converters 11, 20, 22, 24 and 25, and the valves 4 and 17. The actuating signals are fed to the individual components via lines which are not shown in more detail.

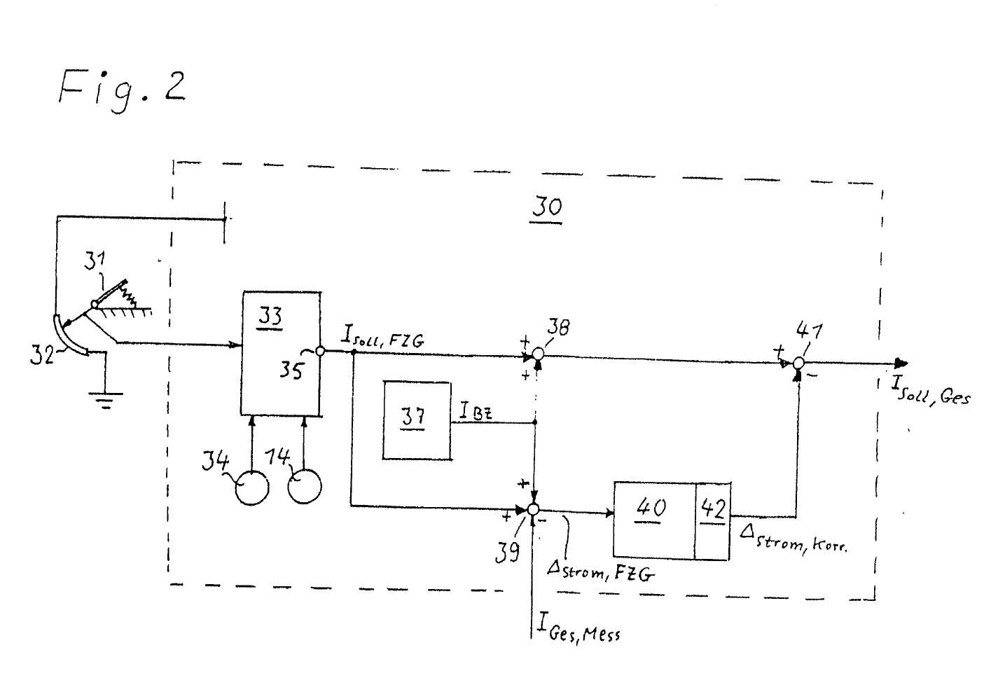

Details of the controller 30 are illustrated in the block diagram of FIG. 2. The accelerator pedal 31 has an accelerator pedal position transmitter 32 which is illustrated in FIG. 2 by a potentiometer symbol. The accelerator pedal position transmitter 32 can also, however, be an absolute shaft-angle encoder which converts an angular position into an item of digitally represented information. The accelerator pedal position transmitter 32 is connected to an input (not illustrated in more detail) of the controller 30. The information corresponding to the respective angular position of the accelerator pedal 31 is processed digitally in the controller 30 and converted into digital data if it is not already output digitally by the accelerator pedal position transmitter.

Present in the controller 30 is a component with a memory 33 in which characteristic diagrams are stored. The characteristic diagrams relate to vehicle current setpoints as a function of the accelerator pedal positions and, at least, of the values, provided during operation of the vehicle, of the voltage of the fuel cell 2 and the rotational speeds of the traction motor 19. The digital positional values of the accelerator pedal 31, the digital values of the rotational speeds of the traction motor 19, which has a tachometer generator 34, and the digital values of the voltage across the poles of the fuel cell 2 are fed to the component with the memory 33 in order to read out from the memory 33 the vehicle current setpoints assigned to these variables. The vehicle current setpoints which are present at the output 35 of the memory 33 are output as a function of the position of the accelerator pedal 31, the rotational speed of the traction motor and the fuel cell voltage. If appropriate, further variables of the vehicle which affect the level of the vehicle current setpoints can be taken into account in the characteristic curves as parameters and fed, together with the accelerator pedal values, the rotational speed values and the fuel cell voltage values, to the memory 33, which outputs vehicle current setpoints taking into account these further variables.

A specific power of the traction motor 19 requires a specific current, which can be generated by the fuel cell 2 only with a specific energy consumption of the auxiliary units, for example the compressor 9. For this purpose, the auxiliary units require current which must, in turn, be supplied by the fuel cell 2 during driving operation. The currents required for the various current setpoints or accelerator pedal positions and which the fuel cell system 1 required, for example, for its auxiliary units, can be measured for the respective vehicle and stored as characteristic diagrams in a memory 37 of the controller 30. It is also possible to calculate the intrinsic current value requirement of the fuel cell system 1 for the operating states described above and store these values in the characteristic diagrams. These stored values are very accurately observed during operation of the vehicle. The stored intrinsically required current values are also denoted below as estimated values.

The vehicle current setpoints output from the memory 33 are denoted in FIG. 2 by I_{soll,FZG} and are used to address the memory 37, in order to read out the assigned current values of the intrinsic consumption of the fuel cell system 1. That is, the estimated values which are denoted in FIG. 2 by I_{BZ}. The vehicle current setpoints I_{BZ} for the driving operation I_{soll,FZG} are added to the current values of the fuel cell system 1. This is illustrated in FIG. 2 by a summing point 38. The measured output current of the fuel cell 2, which is denoted by Ig_{es.,Mess.} in FIG. 2 is subtracted from the sum of the respective vehicle current setpoints I_{soll,FZG} for the driving operation and the read-out current value (estimated value) I_{BZ} of the fuel cell system, (i.e., the sum I_{soll,FZG}+I_{BZ}). The subtraction is illustrated in FIG. 2 by the summing point 39. The subtraction at the summing point 39 produces a vehicle differential current value which is denoted in FIG. 2 by Δ_{strom,FZG} and is applied to a controlling system 40 which outputs a dynamically corrected differential current which is denoted in FIG. 2 by Δ_{Strom,Korr}. The differential current Δ_{Strom,Korr} is added to the total current setpoint _{Soll,FZG}+I_{BZ} with the correct sign. This is illustrated in FIG. 2 by a summing point 41. The summing point 41 supplies a corrected total current setpoint I_{soll,Ges} for controlling the metering of the fuel feed to the fuel cell 2. Integrated in the controlling system 40 is a delay arrangement 42 which relays the differential current Δ_{Strom,FZG}, to the downstream summing point 41 with a delay time which can be set. In a way known per se, for example with the aid of characteristic curves stored in the controller 30, the total current setpoint is used to determine a setpoint for the compressor 9 whose rotational speed is set by means of the converter 11 and the motor 10 to a setpoint rotational speed for metering the fuel of the fuel cell 2.

The delay time of the delay arrangement 42 is tuned to the characteristic of the fuel cell system 1, in the case of which a delay time exists between the setpoint stipulation and the corresponding fuel flow, for the fuel cell 2. Consequently, a delay time is set for the total current setpoint in the delay arrangement 42. This new delay time is greater than the previously mentioned delay time of the fuel cell system 1.

The fuel metering for the fuel cell 2 is set with the aid of the measures described above such that the request corresponding to the accelerator pedal position and the energy already consumed by the electrical device at the instant of the request are taken into account by an appropriate corrected dynamic setpoint stipulation.

The existing energy requests of the various current device in the two electrical systems of the vehicle are therefore taken into account without the need for dedicated measurement of the current consumption of each individual electric component in the vehicle. Although, because of the numerous devices, the current consumption of the low-voltage network 26, in particular, can frequently change during a journey because, for example, an air-conditioning system with a high current consumption draws current in a fashion varying with time, the request of the current of the fuel cell is adapted to the request for the traction motor 19 owing to the consumption of the other electric components of the vehicle. The fuel metering by means of the measures described above is based on the accelerator pedal request, the rotational speed of the traction motor, the fuel cell voltage and the internal current consumption of the fuel cell system, estimated by reading out the characteristic curves of the fuel cell system, and by checking whether the current consumption thus determined corresponds to the actual current consumption. If there is correspondence, the total current setpoint is processed further without change for the purpose of fuel metering. If the check yields a deviation between the requested and actual current consumption, a corresponding correction of the total current setpoint is carried out. If more current is requested than is returned by the measurement of the current, the total current setpoint is reduced correspondingly. If a higher current consumption is measured than that requested, the total current setpoint is correspondingly increased.

By way of example, for a traction motor power of 40 kW at 4 000 rpm and an output voltage of the fuel cell 2 of 200 V a current setpoint I_{Soll,FZG} of 200 A is requested by a corresponding angular position of the accelerator pedal 31. It may be assumed that a current of 25 A is consumed in the vehicle by consumers in the low-voltage network 26, because an air-conditioning system is switched on, for example. If a current setpoint of 200 A were prescribed, the fuel cell voltage would drop, and this would entail poor efficiency and, if appropriate, emergency shutdown because of overshooting of prescribed limiting values. The measures described above add to the current requested in accordance with the accelerator pedal position an estimated current setpoint of the fuel cell system 1 drawn from the characteristic curves in accordance with the angular position, the result being a total current setpoint of 225 A. However, the current measurement indicates a total current of 250 A because of the additional current consumption of 25 A. A corrected total current setpoint of 250 A is therefore produced with the aid of the method according to the invention.

It may further be pointed out that other motor-driven, mobile devices such as boats, rail-bound vehicles or aircraft are also equivalent within the meaning of the invention to the vehicle.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for automatically correcting a current setpoint which is influenced by the respective accelerator pedal position of a vehicle, said method comprising the steps of:
operating at least one electric drive unit supplied with current by a power supply system, having a setpoint which includes both the current for the drive unit and currents which are additionally output to electrical devices by the power supply system,
storing vehicle setpoints, such that they can be read out, in characteristic diagrams as a function of the accelerator pedal positions, the rotational speeds, of the drive unit and the voltage values, provided during operation of the vehicle, of the power supply system, and/or being capable of calculation by means of formulae, with the vehicle current setpoint corresponding to a respective accelerator pedal position and a respectively existing rotational speed of the drive unit,
reading out voltage of the power supply system from the characteristic diagrams and/or calculated using the formulae,
forming a sum from the vehicle current setpoint and the value, corresponding to the respective operating state and read out from characteristic diagrams, of the intrinsic consumption of the power supply system being formed,
forming a difference between the current consumed in the vehicle at the instant of the respective stipulation of the vehicle current setpoint and the sum, and
adding a dynamically corrected differential current setpoint, with the correct sign, to the sum of the vehicle current setpoint and an intrinsic consumption current setpoint in order to form the corrected current setpoint from which the current output of the power supply system is determined.

2. The method according to claim 1, wherein the power supply system is a fuel cell system with a fuel cell for the current output, wherein data concerning the intrinsic current consumption of the fuel cell system are stored in the characteristic diagrams, and wherein the dynamically corrected differential current setpoint is added with the correct sign to the sum of the vehicle current setpoint and intrinsic consumption current value in order to form the corrected current setpoint, to provide fuel metering of the fuel cell is determined for the current output.

3. The method according to claim 1, comprising the further step of adding the corrected differential current setpoint with a time delay, which is greater than the delay time of the fuel cell system, to the sum of the vehicle current setpoint and intrinsic consumption current value in order to form the corrected current value, which determines the fuel metering of the fuel cell.

4. The method according to claim 1 comprising the further step of measuring the total current consumed in the vehicle at the instant of the vehicle current setpoint stipulation by means of at least one current transformer which is arranged at an output of the fuel cell upstream of branches to said electrical devices of the vehicle.

5. An arrangement for automatically correcting a current setpoint which is influenced by the respective accelerator pedal position of a vehicle, for operating at least one electric drive unit supplied with current by a power supply system, having a setpoint including both the current for the drive unit and currents which are additionally output to electrical devices by the power supply system, said arrangement comprising:
an accelerator pedal position transmitter connected to an accelerator pedal in the vehicle,
a respective transmitter each for measuring each of the output current and the voltage of a fuel cell of the fuel cell system and the rotational speed of the drive unit,
a controller connected to said transmitter, said controller being arranged in the vehicle and in which vehicle current setpoints are stored, such that they are read out, in characteristic diagrams as a function of the accelerator pedal positions, the rotational speeds of the drive unit and the voltage values, provided during operation of the vehicle, of the power supply system, and/or calculated by formulae wherein the vehicle current setpoint, corresponding to the respective accelerator pedal position and the respectively existing rotational speed of the drive unit and voltage of the power supply system, are read out from the characteristic diagrams and/or calculated using the formulae,
summing device for forming a sum from the vehicle current setpoint and the value, corresponding to the respective operating state and read out from characteristic diagrams, of the intrinsic consumption of the power supply system, said controller determining the difference between the total current consumed in the vehicle at the instant of the respective stipulation of a vehicle current setpoint and the sum of the vehicle current setpoint and the value of the respective intrinsic consumption of the power supply system and said controller producing a dynamically corrected differential current setpoint with the correct sign relative to the sum of the vehicle current setpoint and intrinsic consumption value in order to form the corrected current setpoint, for aiding in the setting of the aid of which the current output of the power supply system.

6. The arrangement according to claim 5, wherein the power supply system is a fuel cell system with a fuel cell.

7. The arrangement to claim 5, wherein the controller includes a delay arrangement for the dynamically corrected differential current setpoint, the time delay of which is greater than the delay time of the fuel cell system.

8. The arrangement according to claim 6, wherein a current transformer is arranged at an output of the fuel cell upstream of branches of the high-voltage network, connected to the fuel cell.
